(19) United States
(12) Patent Application Publication
(10) Pub. No.: US 2010/0048416 A1
(43) Pub. Date: Feb. 25, 2010

(54) ENCODED MICROSPHERE

(76) Inventor: Robert Wilson, Liverpool (GB)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/522,978

(22) PCT Filed: Jan. 11, 2008
(86) PCT No.: PCT/GB08/00092

§ 371 Date: Aug. 18, 2009

(30) Foreign Application Priority Data
Jan. 11, 2007 (GB) 0700532.5

(51) Int. Cl. C40B 30/04; C40B 60/00; B05D 7/00

(52) U.S. Cl. 506/9; 506/33; 427/214

(57) ABSTRACT

There is disclosed a method for encoding a microsphere comprising the steps of i) providing a layer of a polyionic polymer to the microsphere, ii) coating the layer with quantum dots, iii) providing a layer of a transparent polyionic polymer to the coated polymer layer and iv) coating the transparent layer with the same and/or different quantum dots and, optionally, repeating steps iii) and iv) whereby to characterise the microsphere by the wavelength and/or intensity of its photoemission spectrum on excitation at a predetermined wavelength of incident light.

The present invention is directed to a method for encoding a microsphere, an encoded microsphere and uses thereof. It is particularly, although not exclusively, concerned with use of the encoded microsphere for multiplexed assays, especially in relation to explosive mixtures.

Modern analytical methods are increasingly characterised by a requirement for screening of large compound libraries. Although traditional planar (two-dimensional) arrays are ideal for this purpose, they are accompanied by problems associated with diffusion and reproducibility which make them unsuitable for quantitative assay.

A suspension (three-dimensional) array can avoid many of these problems and offer reliable quantitative assay where specifically functionalised substrates can be manufactured in large quantity with high reproducibility. However, the freedom of movement available to substrates in suspension means that they must contain some kind of code which enables them to be uniquely identified.

Commercial substrates for suspension array are based on polystyrene microspheres in which one or more fluorescent dyes have been trapped by a swell-shrink cycle.

Their use for multiplexed assays is, however, restricted by poor reproducibility in manufacture where high levels of encoding are required, the need for solvent compatibility in the dyes and the avoidance of overlapping excitation or emission spectra which limit the number of codes and by the cost of decoding instruments requiring multiple excitation sources.

The present invention generally aims to provide a method for the production of encoded microspheres which overcomes the above-mentioned limitations.

Quantum dots (QDs) are known to give rise to size-dependent photoluminescent emission spectra of narrow bandwidth (20 to 30 nm) and have been used to label a wide variety of solid substrates.

For example, polystyrene microspheres including a paramagnetic material can be labelled by trapping quantum dots (S. Mulvaney et al., BioTechniques, 2004, 36, 602-607). Encoded non-paramagnetic polystyrene microspheres can be similarly prepared (X. Gao and S, Nie, Anal. Chem., 2004, 76, 2406-2410; M. Han, et al., Nature, 2001, 631-635).

A quantum dot labelled polystyrene microsphere has been prepared using layer-by-layer (LbL) chemistry (D. Wang et al., Nano Lett., 2002, 2(8), 857-861). This self-assembly chemistry has also been used for quantum dot labelling of negatively charged ferric oxide nanoparticles (X. Hong et al., Chem. Mater., 2004, 16, 4022-4027).

It has now been found that LbL chemistry can provide microspheres encoded by quantum dots on a large scale and with good reproducibility.

Accordingly, in a first aspect, the present invention provides a method for encoding a microsphere comprising the steps of i) providing a layer of a polyionic polymer to the microsphere, ii) coating the layer with quantum dots, iii) providing a layer of a transparent polyionic polymer to the coated polymer layer and iv) coating the transparent layer with the same and/or different quantum dots and, optionally, repeating steps iii) and iv) whereby to characterise the microsphere by the wavelength and/or intensity of its photoemission spectrum on excitation at a predetermined wavelength of incident light.

As used herein the term “quantum dot” will be understood to refer to a particle of a semiconductor material having a dimension smaller than the exciton Bohr radius corresponding to the bulk material.

References to different quantum dots herein are references to the same and/or other such materials which have particle dimension such that they emit light at the predetermined wavelength of incident light which can be resolved light emitted by any other. References to the same quantum dots will be construed accordingly.

As used herein, the term “microsphere” will be understood to refer to a particle, particularly, although not essentially, to a particle of circular cross-section, which has largest dimension or mean diameter ranging from 1 to 10 μm.

The term “transparent” as used in relation to a polyionic polymer or material will be understood to mean that the polymer or material permits the propagation of light capable of exciting the quantum dots as well as the propagation of light emitted from them. The transparent polymer or material may, in particular, permit the propagation of wavelengths of light ranging from 250 to 1400 nm.

In one embodiment, the microsphere is functionalised by an uncharged organic moiety capable of forming a covalent bond with a polyionic polymer.

In this embodiment, the method provides a base, polyionic polymer layer which is covalently bound to the microsphere. The covalently bound polymer layer is suitable for direct coating with quantum dots by step ii)—and the method avoids the need for one or more priming layers.

The method may nonetheless include the preliminary step of providing one or more priming layers to the microsphere. The preliminary step may use one or more polyionic polymers such that the final priming layer is of opposite charge to the polyionic polymer of step i).

The preliminary step may also result in a covalently bound base polymer layer—but embodiments in which the polymer is provided by an electrostatic interaction with microspheres are also possible.

The method may use polyionic polymers of high molecular weight (≧10 kDa) for these steps—in particular, high molecular weight polyamines (≧10 kDa) such as poly(allylamine), poly(ethyleneimine), poly(lysine) and chitin and/or negatively charged polymers such as poly(sodium 4-styrenesulphonate).

Where the microsphere is charged (for example, by SO₃²⁻) the method may additionally use high molecular weight (≧10 kDa) polyelectrolytic salts—such as those based on poly(diallyldimethylammonium) or poly(4-vinylpryridine) for these steps.

Other suitable polyionic polymers will be known to those skilled in the art. It will be understood, however, that the method does not require a transparent polyionic polymer for these steps.

However, a transparent polyionic polymer is always required for step iii). The method may use any one of the aforementioned polymers for this step.

The microsphere may comprise any suitable material, for example, a functionalised latex or silica. Advantageously, the microsphere is paramagnetic—so as to permit convenient handling by magnetic precipitation during the separation and re-suspension steps accompanying the method.

The microsphere may, in particular, comprise an epoxy-functionalised, paramagnetic or non-paramagnetic, polystyrene microsphere (˜4.5 μm)—available from Dynal (UK) and Spherotech (US) respectively.

Paramagnetic microspheres of smaller diameter may also be suitable provided that they can be separated from suspension within a reasonable time period. A suitable paramagnetic microsphere of diameter 300 nm (Estapor®) has recently become commercially available from Merck.

The method may use quantum dots which comprise compounds of Group II-VI elements, for example CdSe, or Group III-V elements, for example InP. It may use quantum dots having an overcoat of a material of larger band gap but limited mismatch in crystal structure (for example, ZnS)— in order to increase photoluminescent quantum yield.

It has been found that where, for example, the method uses an excess of quantum dots for step iii), the amount of quantum dots deposited to a polyionic layer is determined largely by surface area.

The method may, therefore, reproducibly load a precise amount of quantum dots to the microsphere.

Furthermore, the intensity of the photoemission spectrum of a microsphere on which step iv) uses the same quantum dots as step i) is roughly twice the intensity at the relevant emission wavelength of that of a microsphere on which step iv) uses different quantum dots.

The method may, therefore, repeat steps iii) and iv) a predetermined number of times whereby to load the microsphere with a desired amount of one or more quantum dots.

The method may use an excess of quantum dots for all steps ii) and iv) and repeat steps iii) and iv) from 1 to 20 times (for example, at least once, twice or three times) using the same and/or different quantum dots to those used in preceding step ii) and/or any one preceding step iv).

The method may, in particular, repeat steps iii) and iv) using different quantum dots for each step iv) to those used in the preceding step ii) or any preceding step iv).

The amount of quantum dots encoding the microsphere is to a lesser extent also controlled by the number of priming layers and/or the inclusion of one or more intervening layers.

In one embodiment, therefore, the method comprises an additional step following step i) and/or steps iii) of providing one or more intervening layers of a transparent polyionic polymer.

In this embodiment, the method may use the high molecular weight polymers mentioned in relation to step iii) for the additional step.

The number of times steps iii) and iv) can be repeated with or without the additional step appears limited only by practical considerations of time and economy.

In this regard, a paramagnetic microsphere is particularly advantageous—in that it permits rapid separation of the microsphere from solution by magnetic precipitation. The method may, therefore, avoid time consuming and complicated separation techniques such as filtration and centrifugation.

In one embodiment, each step of the method is performed in a protic solvent and steps ii) and iv) use an excess of quantum dots (opposite in charge to the polymer).

In this embodiment, the quantum dots may, in particular, be capped by a negatively charged moiety—for example, thioalkyl carboxylate. Such quantum dots can, for example, be obtained by treatment of commercially available tri-n-octylphosphine oxide (TOPO)- or tri-n-octylphosphine (TOP)-capped quantum dots with mercaptoacetic acid.

The method may provide for encoding by consecutive layers of polymer coated in the same quantum dots. For example, the method may comprise five consecutive steps ii) and iv) using green quantum dots followed by five consecutive steps iv) using red quantum dots.

In another embodiment, steps ii) and iv) of the method are performed in an aprotic solvent using an excess of quantum dots and steps i) and iii) are performed in a protic, solvent.

In this embodiment, the method may, in particular, use commercially available TOPO- or TOP-capped quantum dots mentioned above. However, quantum dots capped by other hydrophobic ligand may be suitable—especially if they are monovalent and/or can be displaced by, or interact with, the polyionic polymers used for steps i) and iii).

In this embodiment, however, it is essential, in order to avoid irreversible aggregation on transfer of the microsphere between protic (for example, water) and aprotic solvent that steps i) and iii) are each followed by a drying step and that steps ii) and iv) are each followed by a wetting step.

The drying step may comprise washing with a suitable organic solvent but other means for removing water may be employed. The wetting step may comprise washing with an organic solvent which is miscible in water whereby to substantially remove the aprotic solvent.

The aprotic solvent may, in particular, comprise chloroform—and in that case both the drying and the wetting step may simply comprise washing with methanol.

Those skilled in the art will appreciate that, in this embodiment, the assembly of quantum dot to polymer covered microsphere can not be attributed to the electrostatic interactions which are thought to underpin conventional LbL chemistry.

The mechanism remains unclear, but the method may perhaps be described as “amphiphilic” in the sense that microspheres are exposed alternately to protic and aprotic solutions.

A single coating of each quantum dots is sufficient for high intensity photoemission spectra—especially where the polyionic polymer used for steps i) and/or iii) is poly(ethyleneimine).

The method may provide that at least one of step ii) and/or step iv) use an aprotic solvent. It may, alternatively or additionally provide that at least one of step ii) and/or step iv) use a protic solvent.

In one embodiment, the method includes the further step of providing one or more protective layers of a transparent polyionic polymer to the microsphere whereby to encapsulate the QD assembly.

This further step may, in particular, comprise simply repeating the additional step providing for intervening layers. The further step may use any of the above-mentioned polyionic polymers and, in particular, low molecular weight (<10 kDa) polyamines.

The further step may be followed by a coating step providing a protective coating of transparent nanoparticles to the (outer) protective polymer layer. The coating step may, in particular, use silica or germanium oxide nanoparticles—but other transparent nanoparticles, comprising for example chalcogenides, are envisaged. Suitable, negatively charged, silica nanoparticles are available under the trade name Ludox® (Grace & Co., USA).

The coating step may itself be followed by a further step providing one or more layers of a low molecular weight (<10 kDa) transparent polyionic layer to the glass coated layer and repeating the coating step. This further step may be repeated a number of times.

In one embodiment, the method may include the additional step of functionalising the encapsulated microsphere with a molecule capable of recognising a target molecule.

The inventors have found that the vitreous layer can be functionalised by a convenient and short protocol which permits the covalent attachment of a wide variety of molecules.

The functionalising step may, in particular, comprise silanization of the vitreous layer, and chemical modification of the silanized surface, whereby to covalently attach or permit covalent attachment of a molecule capable of recognising the target molecule.

Alternatively, the additional step may comprise providing the (outer) protective polymer layer with a transparent polymer including a moiety a capable of recognising the target molecule. The transparent polymer may electrostatically anchor or covalently attach to the protective polymer layer.

The method is not limited by a requirement for any one type of target molecule—suitable target molecules may comprise chemical compounds, antibodies, anti-antibodies, receptors or nucleic acids sequences.

The molecule or moiety capable of recognising the target molecule may, therefore, comprise any conventional probe—such as an antibody, aptamer, hapten, oligonucleotide sequence or a ligand for a particular receptor.

In one embodiment, the additional step provides to the (outer) protective polymer a transparent polymer (for example, a dextran) comprising an analogue or hapten for one of the explosives RDX, PETN or TNT (see G. M. Blackburn et al., J. Chem. Soc., Perkin Trans. I, 2000, 225-230 and R. Wilson et al., Anal. Chem., 2003, 75, 4244-4249).

In a second aspect, the present invention provides for an encoded microsphere obtainable according to the first aspect.

It will be appreciated, therefore, that the present invention provides an encoded microsphere comprising a core-shell structure in which the core is comprised by the microsphere and the shell by a plurality of quantum dot coated polyionic polymer layers.

In one embodiment, the shell comprises a first layer of quantum dot coated polymer which is covalently bound to the core microsphere.

In another embodiment, the shell comprises a base, priming layer of polyionic polymer which is covalently bound to the core microsphere. In this embodiment, the shell may comprise one or more additional priming layers provided to the base priming layer.

The priming layer(s) and the first layer of quantum dot coated polymer layer need not comprise a transparent polymer—but the second (and any subsequent) polymer layer overlying the first layer should comprise a transparent polyionic polymer.

The priming layer(s) and the first quantum dot coated polymer layer may, in particular, be comprised from the group consisting of high molecular weight (≧10 kDa) polyamines—for example, poly(allylamine), poly(ethyleneimine), poly(lysine) and chitin and/or negatively charged polyionic polymers such as poly(sodium 4-styrenesulphonate).

The second (and any subsequent) overlying polyionic layer may be comprised from the above-mentioned polymers as well as polyionic polymers based on quaternary salts—such as poly(diallyldimethylammonium) and poly(4-vinylpyridine).

It will be apparent that the microsphere is encoded by the shell and, in particular, the number of the quantum dot coated polymer layers as well as the different quantum dots thereon.

The shell may comprise any arrangement of quantum dot coated polymer layers. It may, in particular, comprise two, three, four or five overlying polymer layers each coated with one type of quantum dots. It may additionally comprise one to five polymer layers each coated with a different type of quantum dots—and so on.

The shell may alternatively or additionally comprise two, three, four or five overlying polymer layers each coated with different quantum dots from one another. It may, in particular, comprise multiple layers of polymer coated with one type of quantum dots in which each layer is separated from the other by one or more layers of polymer coated a different type of quantum dots.

The shell may also comprise one or more intervening layers of a transparent polyionic polymer which separate one or more quantum dot coated polymer layers. The polyionic polymer of the intervening layer or layers may be comprised from one or other of the above-mentioned polymers.

In one embodiment, the shell includes a protective layer of a transparent polyionic polymer. The protective layer, which encapsulates the QD assembly, may comprise any of the high molecular weight polymers mentioned in relation to step iii).

The shell may include an overcoat of a transparent material which includes a moiety capable of recognising a target molecule or is or can be adapted to recognise a target molecule.

The overcoat may, in particular, comprise a vitreous layer formed by coating the (outer) protective layer with silica or germanium oxide nanoparticles. It may include additional layers of a low molecular weight (<10 kDa) transparent polyionic polymer, for example polyamine, each of which is coated with silica or germanium oxide nanoparticles.

The (outer) vitreous layer may be functionalised by a covalently attached molecule which is capable of recognising the target molecule.

Alternatively, the overcoat may comprise a layer of a transparent polyionic polymer including a moiety capable of recognising the target molecule which covalently attaches or electrostatically anchors to the (outer) protective layer.

In one embodiment, the encoded microsphere is provided with an overcoat of a transparent polymer (for example, a dextran) comprising an analogue or hapten for one of the explosives RDX, PETN or TNT (see G. M. Blackburn et al., J. Chem. Soc., Perkin Trans. I, 2000, 225-230 and R. Wilson et al., Anal. Chem., 2003, 75, 4244-4249).

The core microsphere may, in particular, comprise any suitable material, for example, functionalised latex or silica. Advantageously, the microsphere is paramagnetic.

In a third aspect, the present invention provides for a library comprising a plurality of encoded microspheres according to the second aspect of the invention.

The library may, in particular, be obtained according to the first aspect of the invention. The method is used to produce a plurality of microspheres each characterised by colour and/or intensity of its photoemission spectrum on excitation at the predetermined wavelength of incident light.

The library may, in particular, comprise encoded microspheres including a protective vitreous overcoat—for functionalising by the end user. Alternatively, the library may comprise encoded microspheres which have already been adapted for a specific use.

In any case, the library may comprise microspheres encoded by the same colour but by different intensities or encoded by the same colour or colours at different intensities. Thus, the encoding may rely on relative as well as absolute intensities.

In a fourth aspect, the present invention provides for use of the encoded microsphere or library for multiplexed assays, multiplexed screening or for combinatorial synthesis.

Such use may, in particular, provide for the detection of a variety of materials including drug, pesticide, explosive and biological materials.

For example, a competitive (reagent limited) immunoassay comprises exposing a sample of suspected explosive material to a mixture comprising two or more suitable antibodies and two or more encoded microspheres, each of which codes for a different hapten for one or other of the explosives RDX, PETN or TNT.

Suitable antibodies comprise antibodies for RDX, PETN or TNT and may, for example, carry a label or a moiety to which a label can be attached following the exposure. In the example below, biotinylated antibodies for RDX, PETN or TNT are labelled after the exposure by sequential treatment with an excess of polystreptavidin and AlexaFluor 660 biotinylated dextran.

The use may also provide for the detection of bacteria, spores and viruses, especially pathogenic types, by targeting certain antigens or nucleic acids sequences.

The multiplexed assays may comprise, for example, a sandwich (reagent excess) assay. It may, in particular, comprise exposing a suitable sample of the suspected material to a mixture comprising two or more suitable (detector) antibodies and two or more encoded microspheres, each of which codes for a (capture) antibody for the a different target molecule.

The detector and capture antibodies may comprise antibodies for the material raised in the same animal species (X)—except where it is desired to label the detector antibodies by anti-species antibody. In that case, the capture antibodies and the anti-species antibody must be raised in a different animal species (Y).

Alternatively, the assay can comprise exposing a suitable sample of the suspected material to two or more encoded microspheres, each of which is conjugated to an oligonucleotide capable of hybridising to a different target oligonucleotide.

The assay may, in particular, target a RNA or DNA sequence—and if appropriate include a preliminary amplification (PCR or ligase chain reaction) step. Suitably, the label may be incorporated during the amplification step. Alternatively, it may be incorporated via a detector oligonucleotide or simply bind to the hybridised molecule.

The label may comprise a fluorescent label—but other types of label are also contemplated. The fluorescent label should emit at a wavelength of light which is resolvable from the light emitted by the various quantum dots at the predetermined wavelength of incident light. Preferably, the fluorescent label emits in the red region and may, for example, comprise AlexaFluor 660 or Cy-5.

It will be appreciated that the use relies on reading and decoding the photoemission spectrum of an encoded microsphere on excitation at the predetermined wavelength.

The detection instrument may, in particular, comprise one or more optical detectors arranged in combination with a number of filters for fixed imaging or high throughput detection.

In one embodiment, the detection instrument comprises a flow cytometer. In any case, the detection instrument may be associated with a computer programme that decodes the encoded microsphere.

The library or encoded microspheres may be included in a test strip (lateral flow) device allowing use with, for example, a fixed imager, in the field and/or by low trained personnel.

In this embodiment, the encoded microspheres typically have mean diameter about a tenth of the medium through which they are to be transported. Suitable diameters are 300 nm or less and in particular, are lower than 150 nm and preferably lower than 100 nm.

The present invention provides a reliable method for large scale production of encoded microsphere with good reproducibility. The method permits very precise loading with quantum dot of more than one colour and in controlled amounts.

Although the examples below are concerned with two or three different colours it will be appreciated that the encoded microsphere may be loaded with additional colours of quantum dots and that each colour may be loaded to a specific intensity.

In theory, therefore, the number of unique codes N that may be obtained is given by the formula N═C^{ν}−1 where C is the number of colours and ν is the number of intensities. Loading with just five different colours of quantum dot in five different amounts may provide 3124 resolvable codes—many more in practice than with fluorescent dyes.

Since each quantum dot may be excited at the same wavelength of incident light use of the encoded microsphere is not limited by a requirement for decoding instruments having a large number of excitation sources.

A paramagnetic core provides for easy and rapid separation of the microsphere from aqueous and aprotic solution. It avoids the need for costly and time consuming filtration and/or centrifugation steps and may permit automation of the method as well as automation in use.

Another advantage of the method is that it can avoid the need to prepare and/or use hazardous mercapto-capped quantum dots.

The method enables production of an encoded microsphere including a vitreous protective layer which can be functionalised according to short and convenient protocols—so permitting versatile use.

The microsphere may, in particular, be rapidly adapted to different target molecules for multiplexed assays, multiplexed screening or combinatorial synthesis.

The present invention will now be described having regard to the following embodiments and with reference to the following examples and drawings in which

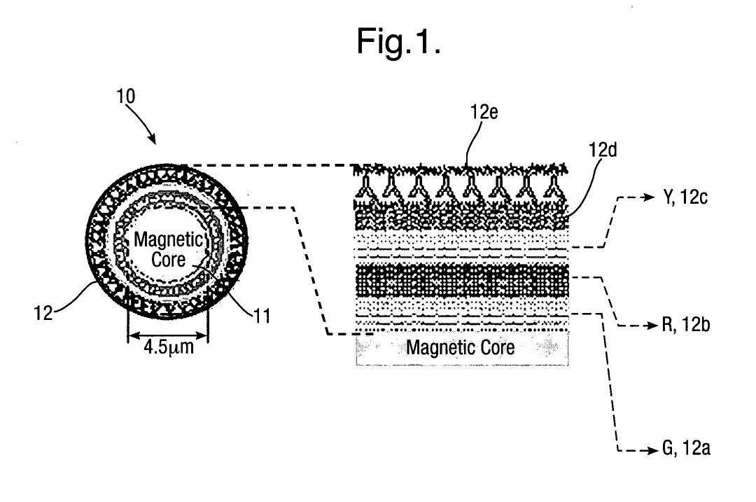

FIG. 1 is a scheme showing an encoded microsphere according to a first embodiment of the present invention;

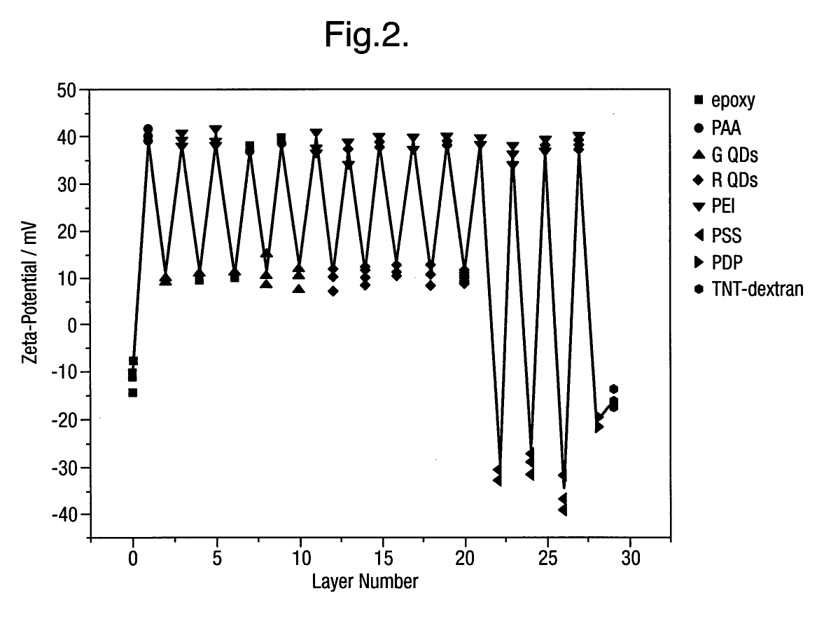

FIG. 2 is a graph plotting zeta (ζ) potentials against number of layers and coatings obtained by micro-electrophoresis during the production of the encoded microsphere of FIG. 1 according to a first embodiment of the method of the present invention;

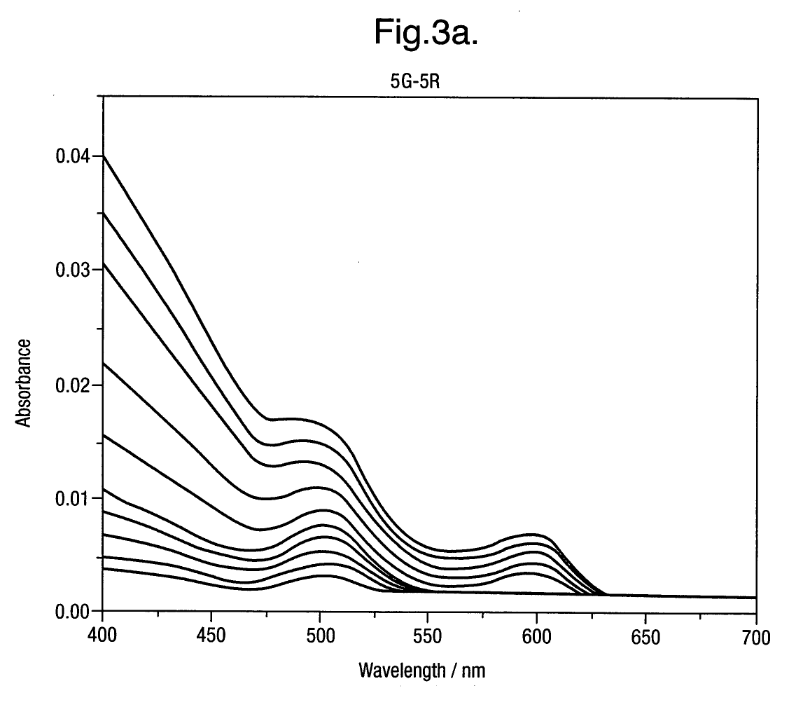

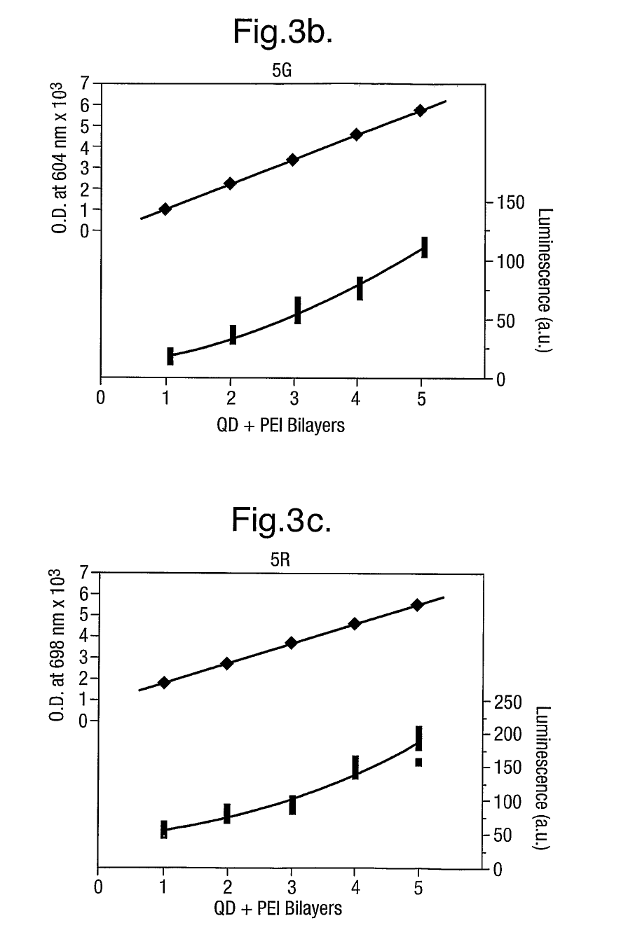

FIG. 3 a) shows UV/visible absorption spectra obtained by LbL assembly of quantum dots on a quartz cuvette in accordance with the first embodiment of the method of the present invention;

FIG. 3 b) shows graphs plotting UV/visible absorbance obtained by LbL assembly of quantum dots on a quartz cuvette and intensity of photoemission spectrum after LbL assembly on microspheres against the number of coatings of quantum dot in accordance with the first embodiment of the method of the present invention;

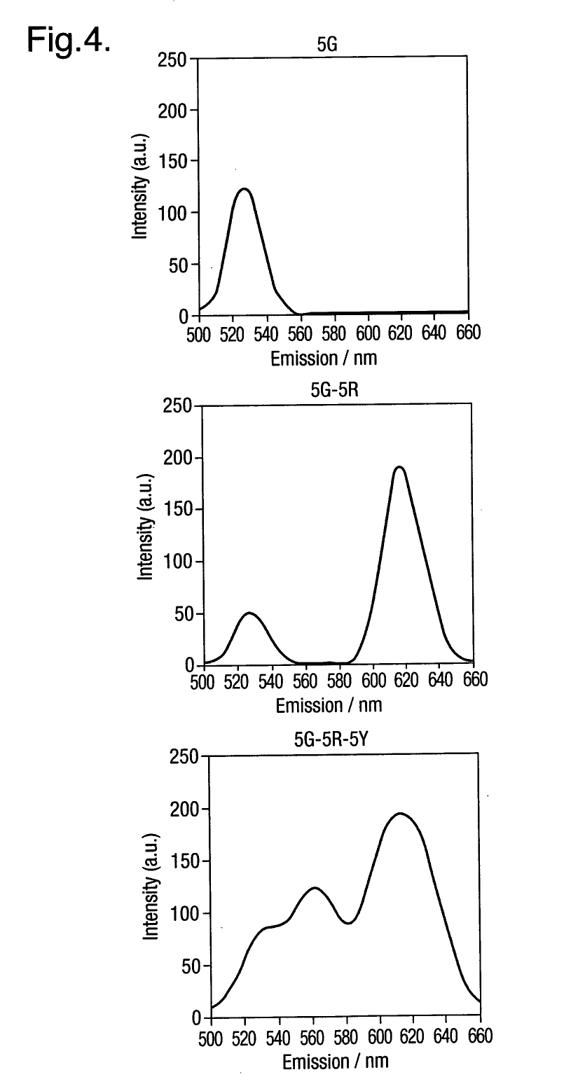

FIG. 4 shows photoemission spectra of a library of encoded microspheres produced according to the first embodiment of the method of the present invention;

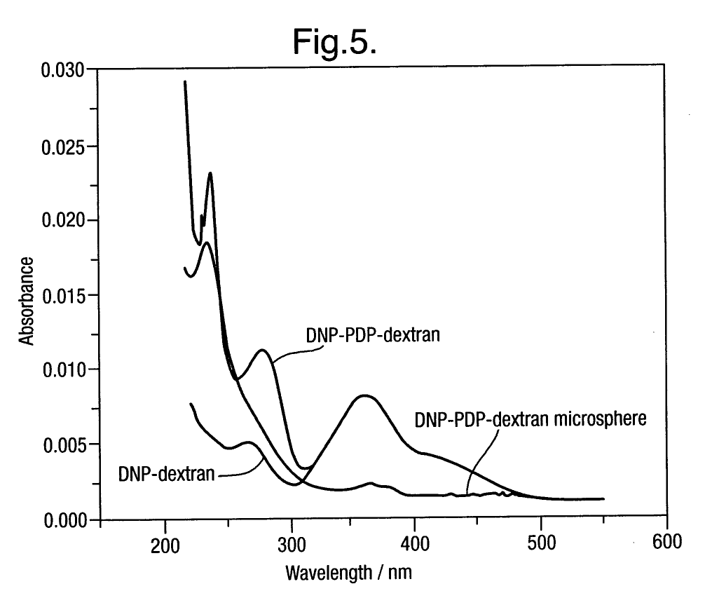

FIG. 5 shows a UV/visible difference absorption spectrum reporting the attachment of a haptenylated dextran to an LbL assembly of quantum dots on a quartz cuvette in accordance with the first embodiment of the method of the present invention;

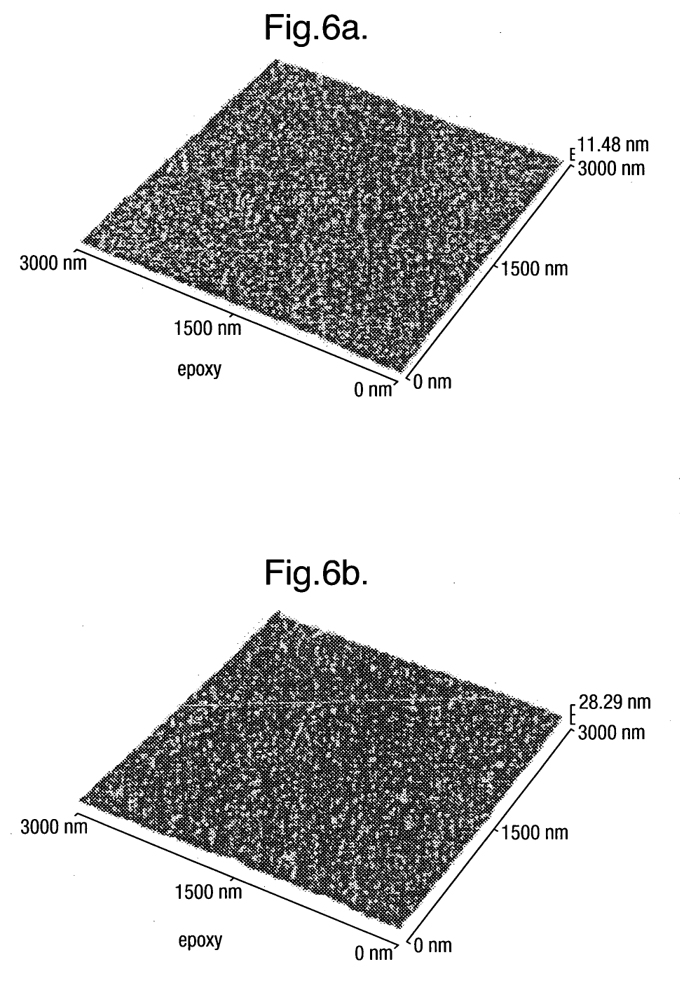

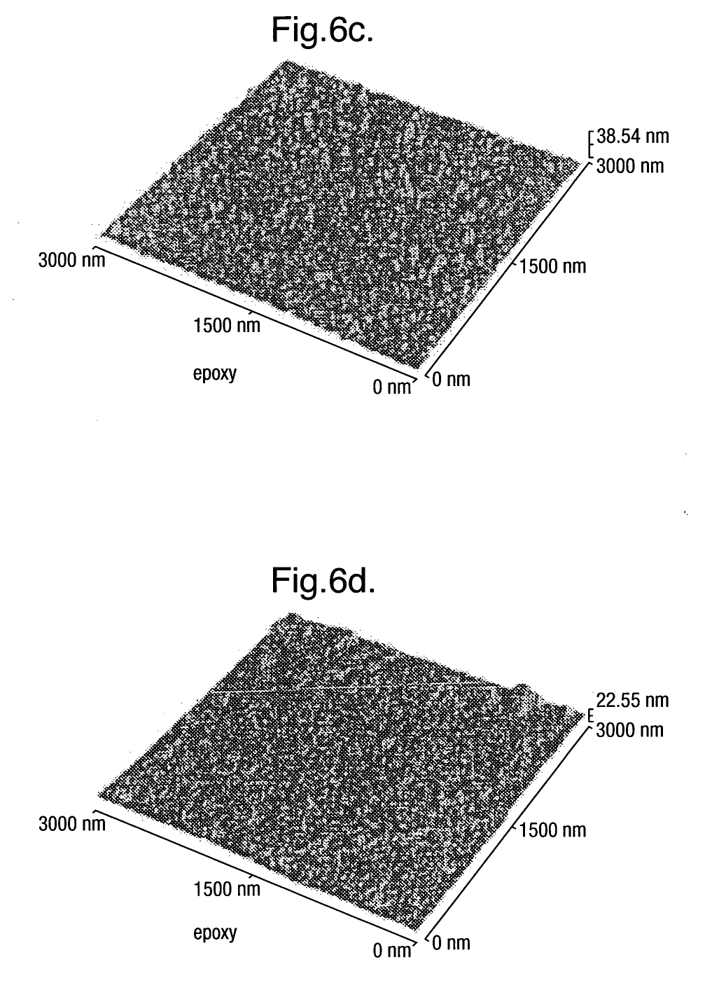

FIGS. 6 a) to d) shows atomic force microscopy (AFM) images obtained during LbL assembly of quantum dots on a glass microslide in accordance with the first embodiment of the method of the present invention;

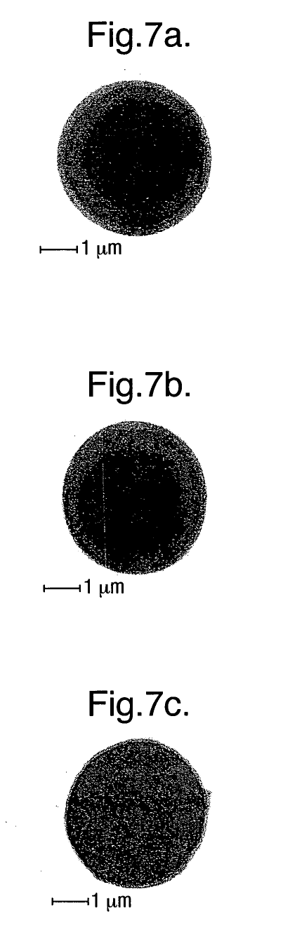

FIGS. 7 a) to c) shows transmission electron microscopy (TEM) images obtained during the production of the encoded microsphere of FIG. 1 in accordance with the first embodiment of the method of the present invention;

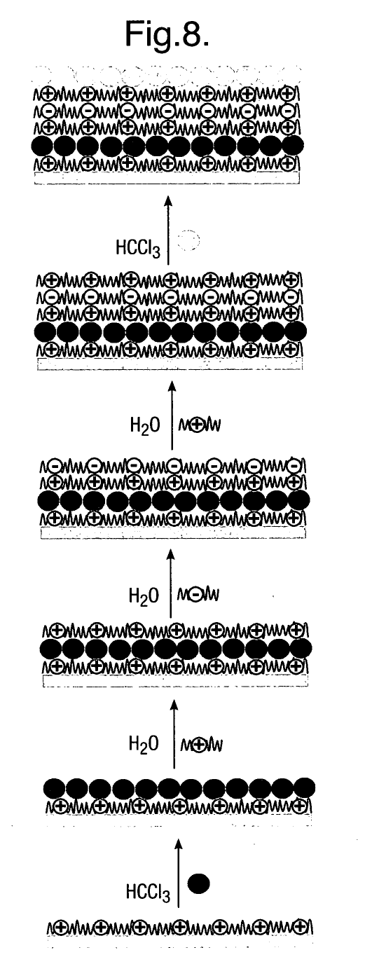

FIG. 8 is a scheme showing the production of an encoded microsphere according to a second embodiment of the method of the present invention;

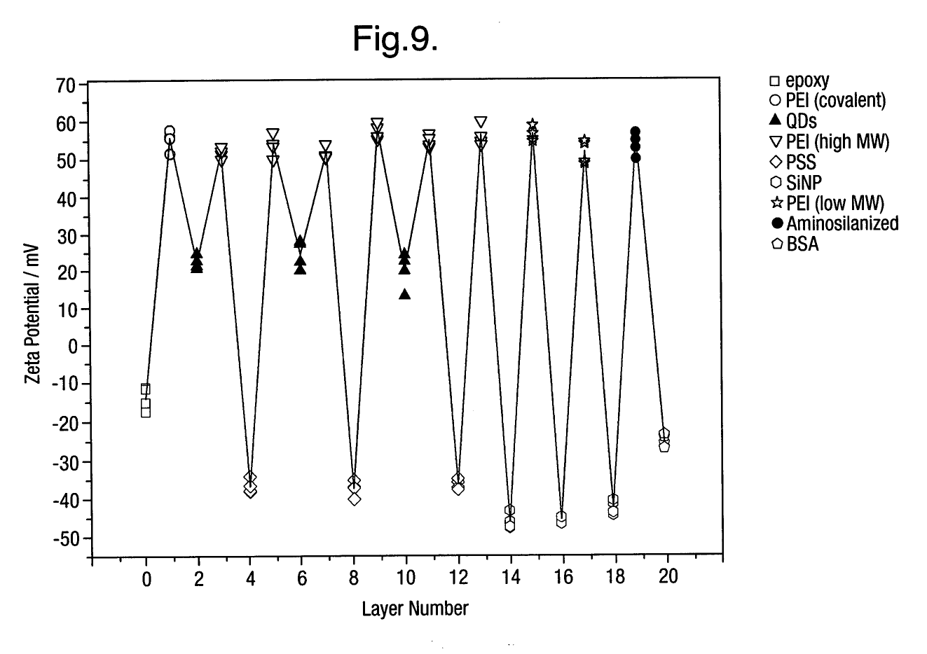

FIG. 9 is a graph plotting 4-potentials against number of layers and coatings obtained by microelectrophoresis during production of an encoded microsphere in accordance with the second embodiment of the method of the present invention;

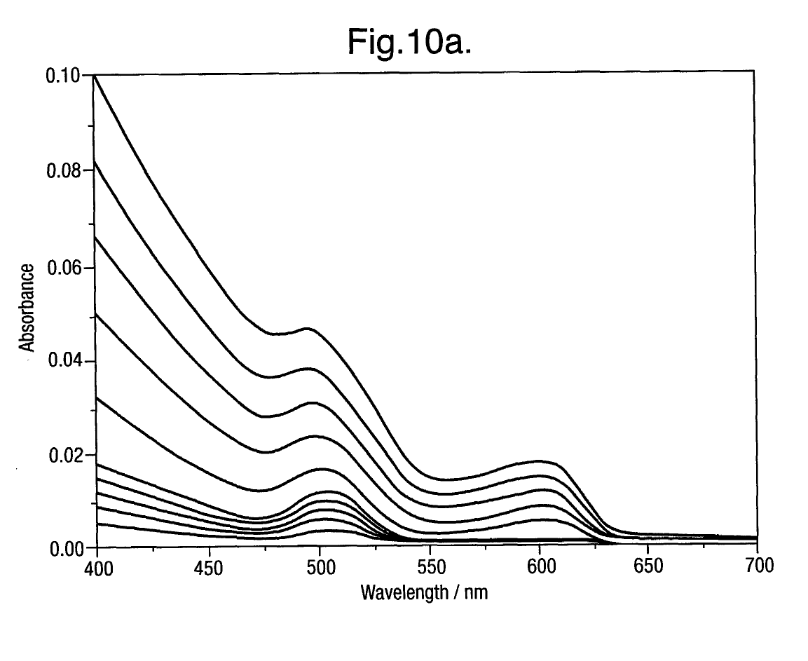

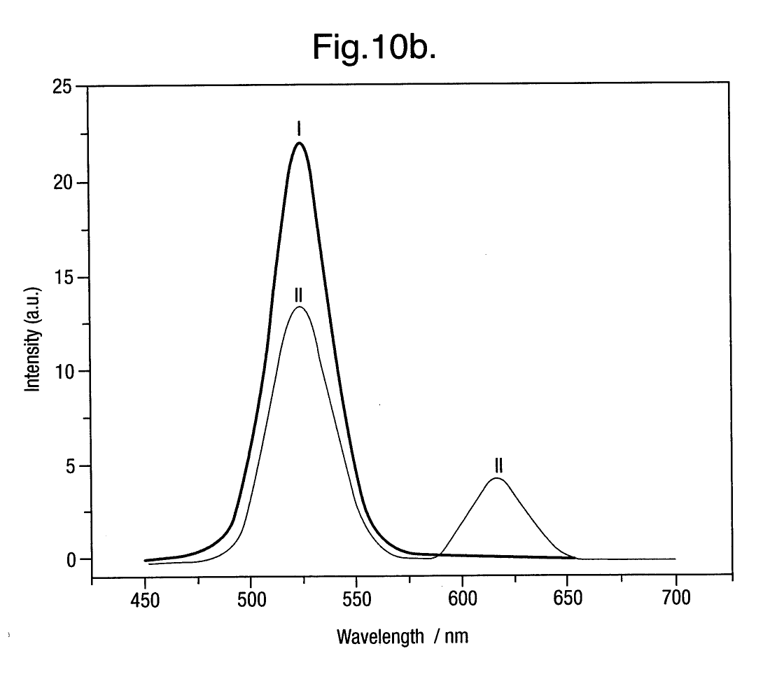

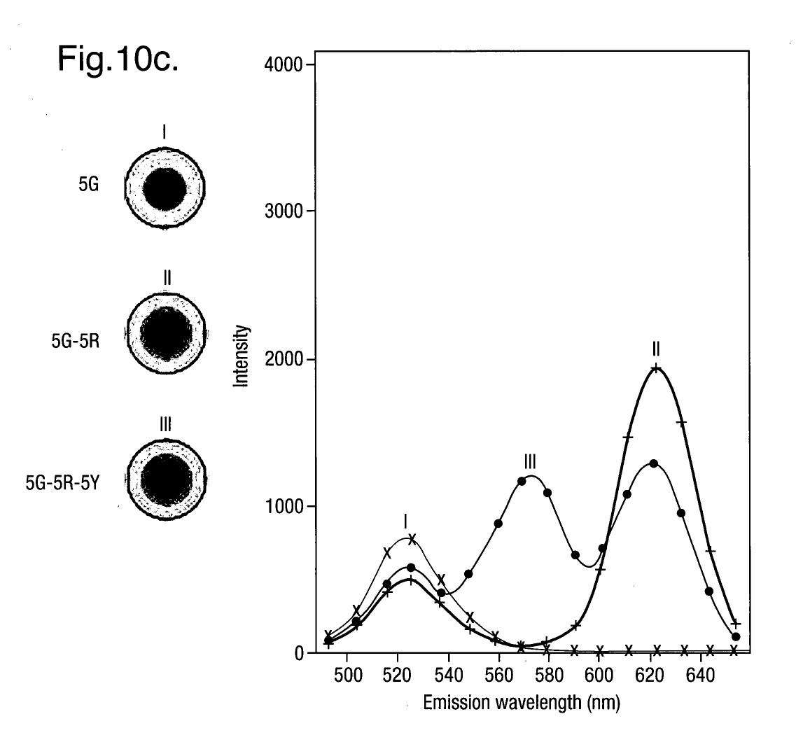

FIGS. 10 a) and b) shows UV/visible absorption spectra and photoemission spectra obtained by LbL assembly of quantum dots on a glass cuvette in accordance with the second embodiment of the method of the present invention;

FIG. 10 c) shows photoemission spectra of a library of encoded microspheres produced in accordance with the second embodiment of the method of the present invention;

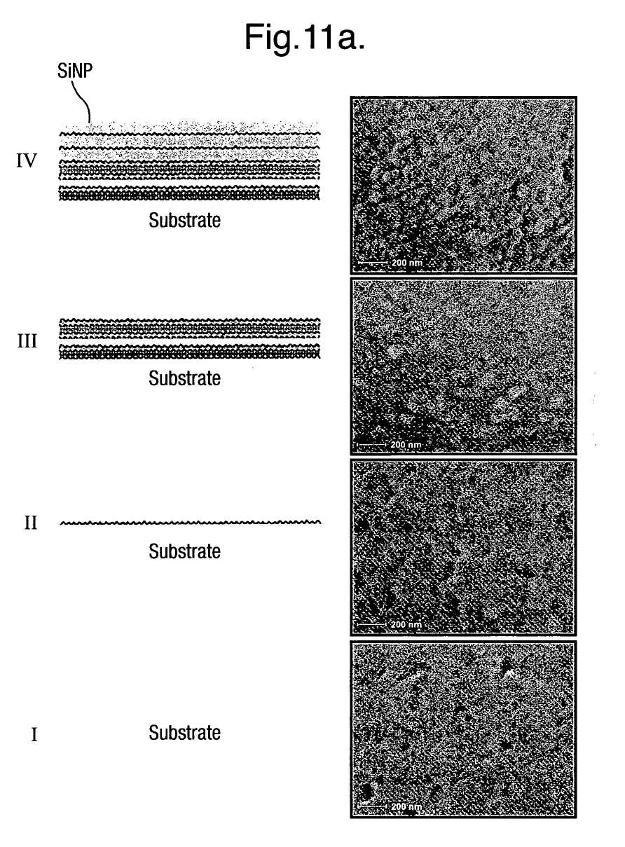

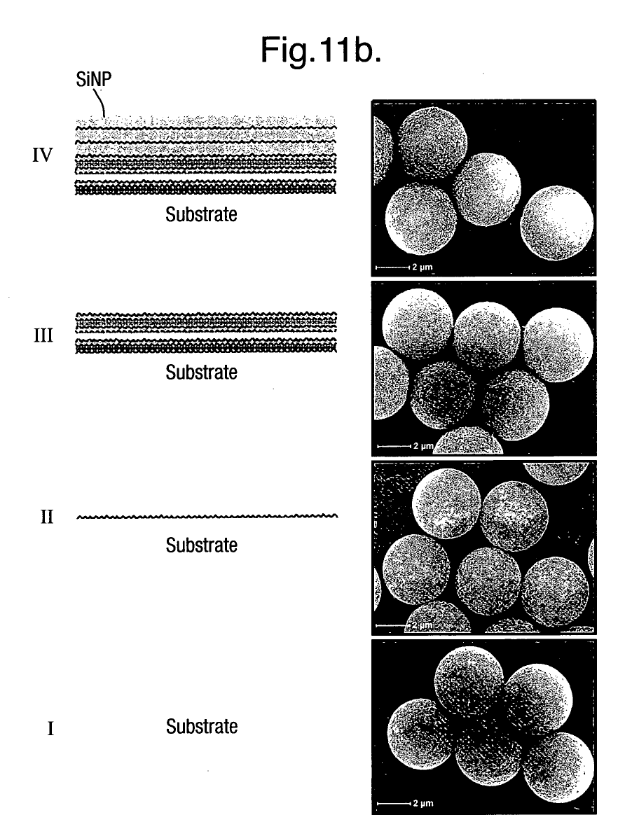

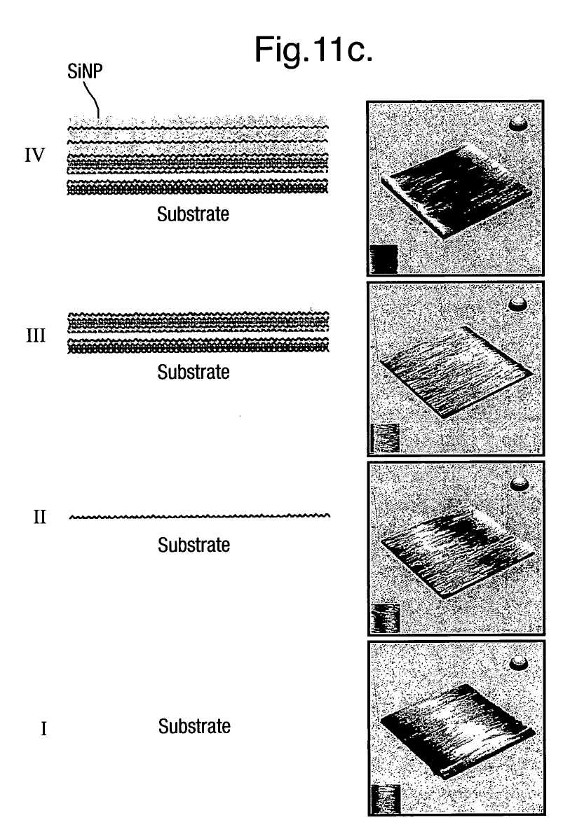

FIGS. 11 a) and c) are respectively scanning electron microscopy (SEM) and AFM images obtained during LbL assembly of quantum dots on a glass microslide in accordance with the second embodiment of the method of the present invention;

FIG. 11 b) shows high magnification SEM images obtained during the production of an encoded microsphere according to the second embodiment of the present invention;

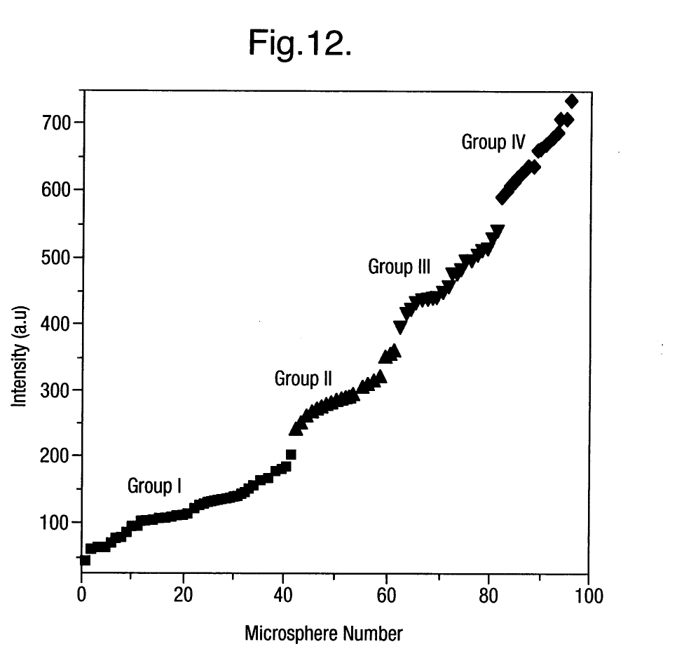

FIG. 12 is a graph plotting the intensities of photoemission spectra obtained in microspheres encoded with 1 to 5 coatings of the same quantum dot;

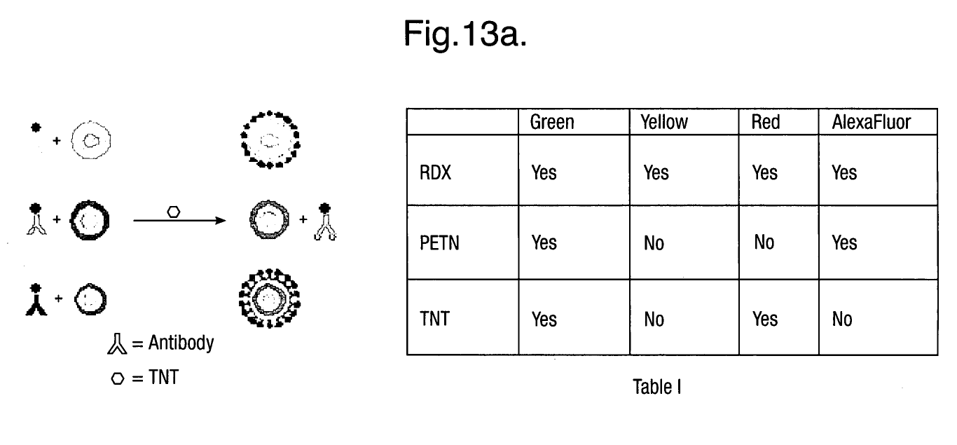

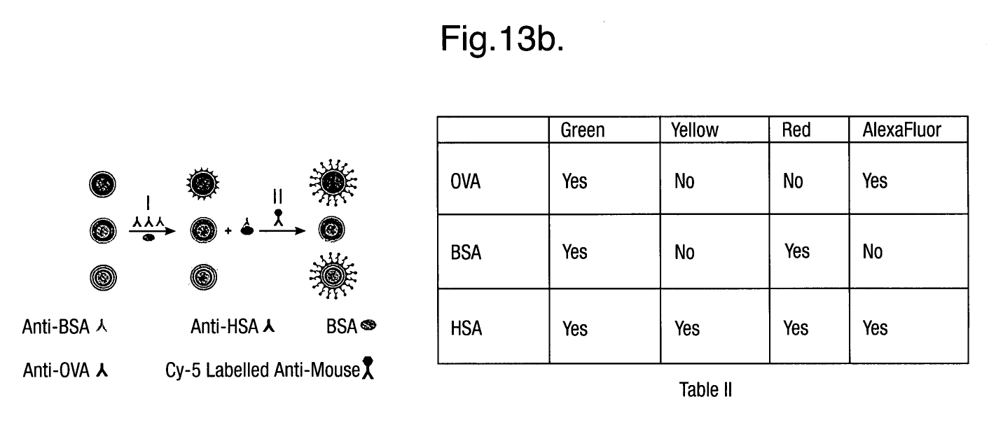

FIGS. 13 a) and b) and 14 are schemes illustrating use of a library of encoded microspheres according to the present invention;

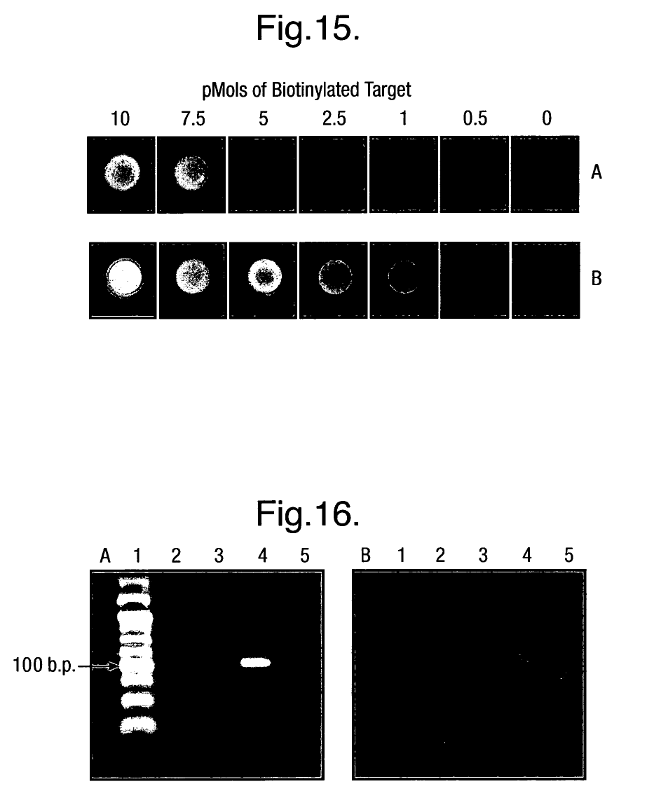

FIG. 15 shows photographs of the photoluminescence of certain microspheres coated with streptavidin and conjugated to a biotinylated oligonucleotide probe sequence; and

FIG. 16 shows photographs of agarose gel chromatograms obtained following PCR of a template DNA and imaged by fluoresence of ethidium bromide (A) and of Cy-5 dye (B).

Referring now to FIG. 1, an encoded microsphere according to the present invention, generally designated 10, comprises a core-shell structure 11, in which a paramagnetic polystyrene microsphere 12 is surrounded by a shell 13 comprising a series a), b), c) of five concentric layers of a transparent polyionic polymer coated with the same quantum dots (green (G), red (R) or yellow (Y)). The encoded microsphere includes protective layers of transparent polyionic polymers 12 d) and an outer layer of a haptenylated dextran 12 e).

The encoded microsphere 10 was produced in accordance with a first embodiment of the method of the present invention—all steps in aqueous solution:

### EXAMPLE 1

### First Layer (Step i)

Paramagnetic, epoxy-functionalised microspheres (200 μl; ˜4×10⁸ microsphere/ml water; mean diameter 4.5 μm; C.V.<5%; Dynal, UK) were washed (5×1 ml) and re-suspended in water (0.5 ml). To the vortexed suspension was added a solution of polyallylamine hydrochloride (PAH; Sigma; MW 70 kDa; 100 mg/ml; pH 8.0) which was prepared by dissolving in 1 M NaCl solution and diluting (1:1) with a solution of 0.1 M sodium tetraborate. After slow tilt rotation (Dynal, MX2 Sample Mixer) overnight, the polyallylamine (PAA) covered microspheres were washed sequentially with water (4×1 ml), 0.1 M sodium borate solution (pH 9.5; 4×1 ml) and 0.1 sodium acetate solution (pH 4.5; 4×1 ml). The latter two steps were repeated and the PAA covered microspheres finally washed with water (6×1 ml).

Referring now to FIG. 2, microelectrophoresis measurements (Brookhaven ZetaPlus potential analyser) made in air-equilibrated HPLC grade water (pH 6.5; 0.005 w % microspheres) show a change in ζ-potential of the microspheres. The change, from −10.9 mV to +40.12 mV—confirms the deposition of a PAA layer to the microsphere.

Brightfield images (not shown) show that there was no cross-linking of microspheres. TEM images (JEOL TEM 2000 FX microscope operating at 200 V; not shown) show a thin halo surrounding the PAA polymer microsphere which was not present in similar images of the epoxy-functionalised microsphere.

### Negatively Charged Quantum Dot

TOPO coated CdSe/ZnS core shell quantum dots (Evident Technologies, USA; 100 μl in toluene) were centrifugally precipitated with methanol (4×1 ml) at 9000 g (15 min.) in a sealable polypropylene vial. The pellet was suspended in chloroform (50 μl) and to the suspension was added thioglycolic (mercaptoacetic) acid (MA; 25 μl; Sigma) followed by a solution (25% in methanol) of tetramethylammonium hydroxide (TMA; 25 μl; Sigma). The vial was sealed and the mixture sonicated (1 min.) before warming in a water bath (60° C.; 1 h). After centrifuge at 9000 g (10 min.), the supernatant was removed and the pellet centrifugally precipitated with methanol (3×1 ml) at 9000 g (15 min.). The washed pellet of MA-functionalised, quantum dots was suspended in 10 mM sodium bicarbonate solution (1 ml) and stored in the dark ready for use.

### First Coating (Step ii)

To a suspension of PAA microspheres (20 μl equivalent to 60 μg) in water (1 ml) is added an excess of MA functionalised, green quantum dots (50 μl) and the mixture (pH 7.0) slow tilt rotated (15 min.). The coated microspheres were magnetically precipitated (Dynal MPC-S Sample Concentrator) and washed with water (4×1 ml; HPLC grade, pH 6.5).

Microelectrophoresis measurements (FIG. 2) confirm the deposition of the green quantum dots to the PAA layer. The ζ-potential of the microspheres became less positive but not negative (+9.93 mV)—suggesting either that the microspheres is not completely covered by quantum dots or that the PAA layer partly envelops them.

Epifluorescence imaging (Leica DMBL fluorescence microscope with SPOT 2 camera (using 100× objective lens at a magnification of 1000×) from SPOT Diagnostics, USA) shows that the microspheres were uniformly photoluminescent.

### Second Layer (Step iii)

The coated microspheres were re-suspended in a solution of branched polyethylene-imine (PEI; MW 750 kDa; Sigma; 1 mg/ml) in 0.5 M sodium chloride (pH 8.0) and rotated (15 min.). The PEI covered microspheres were magnetically precipitated and washed with water (4×1 ml).

The PEI covered microsphere shows greater photoluminescence than the coated microsphere—which is surprising given that UV/visible measurements of these steps applied to a quartz cuvette show that about 30% of the quantum dots are displaced by PEI.

Referring now to FIG. 6, AFM images (Thermomicroscopic Explorer AFM; in tapping mode; scan rate 5.23 μms⁻¹; SPMLAB Version 5.01 software from Windsor Scientific, UK using NanoSensors PPP-NCHR cantilever 125 μm long, tip radius<10 nm, 42 N/m spring constant, 33 kHz resonance frequency) of these steps on epoxy-functionalised glass microslides (a); Genetix, UK) show that the surface of the PEI polymer slide (d) is smoother than the surface of the coated PAA slide (c) and that the latter is more uneven than the surface of the PAA polymer slide (b).

### Second Coating (Step iv)

To a suspension of (PEI) polymer microspheres in water (1 ml) is added MA functionalised, green quantum dot and the mixture slow tilt rotated (15 min). The coated microspheres were magnetically precipitated and washed with water (4×1 ml; HPLC grade, pH 6.5).

### Subsequent Layers and Coatings

Steps iii) and iv) were repeated three times to give (5G) microspheres—five polymer layers each coated with green quantum dot.

### Different Quantum Dots

Steps iii) and iv) were repeated a further five times with MA-functionalised red quantum dot to give (5G-5R) microspheres.

Microelectrophoresis measurements (FIG. 2) confirm the successive deposition of PEI layer and quantum dot coating. As may be seen, the 4-potential of the microspheres oscillated between +38.65 mV and +10.46 mV.

FIG. 3 a) shows the UV/visible spectra when these steps (5G-SR) are applied to a quartz cuvette. FIGS. 3 b) and c) show a linear increase (upper part) in the absorbance of the first exciton peak of quantum dots with number of coatings on the cuvette and that the intensity of luminescence of microspheres increased (lower part) in line with the number of its coatings.

Steps iii) and iv) were repeated a further five times with MA-functionalised yellow quantum dot to give (5G-5R-5Y) microspheres.

The pattern of rougher and smoother surfaces continues as further PEI layers and quantum dot coatings are deposited. Although the surface of the microspheres becomes more uneven as the total number of PEI layers and quantum dot coating increases, FIG. 7 shows that the surface (C) of (5G-5R-5Y) encoded microspheres with 15 PEI layer/coating is only slightly more uneven than the epoxy-functionalised microspheres (A).

Confocal imaging (Zeiss LSM 510 laser scanning confocal microscope; Zeiss META detector) of (5G-5R-5Y) individual microspheres (not shown) confirm the core-shell structure.

Referring now to FIG. 3 c) the photoemission spectra of a library of encoded microsphere is shown. The library comprises 5G, 5G-5R and 5G-5R-5Y encoded microspheres. As may be seen, the intensity of luminescence from the green quantum dots decreases when the microsphere also includes quantum dot that emits at longer wavelength. The effect may be due to radiative and/or non-radiative energy transfer.

### Protective Layers

Step iii) was used to obtain PEI (5G-5R-5Y) encoded microspheres. These microspheres (60 μg) were slow tilt rotated (15 min.) with 0.5M NaCl solution containing poly(sodium 4-styrene-sulphonate) (PSS: MW 70 kDa; Sigma; 1 mg/ml). The PSS covered microspheres were magnetically precipitated and washed with water (4×1 ml). These steps were repeated to give (PEI/PSS)₃ covered microspheres.

The inclusion of the protective layers is confirmed by microelectrophoresis measurements (FIG. 2; for 5G-5R) which showed that the i-potential of the microspheres became negative following treatment with PSS and then positive following treatment with PEI.

### PETN-PDP-Dextran and RDX-PDP-Dextran

To a solution (100 ul) of carboxylated hapten for PETN (or RDX; prepared according to G. M. Blackburn et al., J. Chem. Soc., Perkin Trans. I, 2000, 225-230) in aceto-nitrile (50 mM) was added a solution (1 ml) of 0.2 M N-hydroxysulphosuccinimide, sodium salt (NHSS; Sigma) in 0.1 M sodium phosphate (pH 7.4) and a solution (2 ml) of N′-(3-dimethylaminopropyl)-N-ethylcarbodiimide (EDC; Sigma) in 0.1 M sodium phosphate solution. The resultant mixture was stirred and a solution (1 ml) of aminodextran (70 kDa, Molecular Probes, USA; 22 primary amine/molecule; 10 mg/ml) in 0.1 M sodium phosphate, added. After further stirring (2 h) a solution (400 μl) of 2 mM 3-(2-pyridydithio)propionic acid succinimidyl ester (SPDP; Sigma) in ethanol was added and the stirring continued (1 h). The solution of haptenylated PETN dextran (haptenylated RDX-PDP-dextran) was dialysed (48 h) against water (3×1 l) at 4° C. in darkness.

### TNT-PDP-Dextran

To a solution (4 ml) of PBS containing aminodextran (4 mg, 70 kDa) was added drop wise with stirring a solution (100 μl) of dimethylformamide (DMF) containing DNT-NHS (0.25 mg prepared according to G. H. Keller et al., Anal. Biochem., 1998, 170, 441). After stirring (2 h) a solution (400 μl) of 2 mM SPDP in ethanol was added and the stirring continued (1 h). The solution of TNT haptenylated dextran was dialysed (48 h) against water (3×1 l) at 4° C. in darkness.

### Hapteiylated Microspheres

PEI (5G-5R-5Y) encoded microspheres (60 μg) including protective (PEI/PSS)₃ layers obtained above were re-suspended in a solution of 0.1 M sodium bicarbonate. To this solution was added a solution of SPDP (0.4 mg) in dimethylformamide (DMF) and the mixture slow tilt rotated (30 min.). The addition was repeated and after further rotation (30 min.) the microspheres were washed with 0.1M sodium bicarbonate solution (4×1 ml) and phosphate buffer solution (PBS; 15 mM sodium phosphate, 0.15 M NaCl; pH 7.4; 4×1 ml). The microspheres were re-suspended in a solution of DTT (10 mM) in 0.1 M sodium bicarbonate solution and slow rotated (15 min.).

After magnetic precipitation, the microspheres were immediately re-suspended in buffer solution (0.33 ml; 3×PBS; 45 mM sodium phosphate, 0.45 NaCl; pH 7.4). To the suspension was added a solution (0.66 ml) of haptenylated PDP-dextran in water and the mixture slow tilt rotated at 4° C. overnight. The haptenylated microspheres were washed with PBS (4×1 ml) and water (4×1 ml) and stored in water at 4° C. in darkness.

Referring now to FIG. 2, microelectrophoresis measurements confirm attachment of the haptenylated-PDP-dextran. The 4-potential of the microspheres becomes negative (−20.95 mV).

Referring now to FIG. 4, the difference UV/visible spectrum obtained by subtracting the underlying spectrum of the LbL assembly from the spectrum acquired for the haptenylated LbL assembly on a quartz cuvette shows a peak at 362 nm corresponding to DNP-PDP-dextran.

The stability of the haptenylated layer appears good—shaking with a solution of bovine serum albumin (BSA) in PBS (16 h) resulted in no recognisable change in this spectrum.

Referring now to FIG. 13 a), a competitive assay for TNT employed a suspension array of encoded microspheres produced according to Example 1.

### EXAMPLE 2

### AlexaFluor 660 Biotinylated-Dextran

obtained under conditions of low light as follows: To a stirred solution (2.5 ml) of aminodextran (500 kDa; 98 primary amine per molecule; Molecular Probes, USA; 5 mg) in PBS was added a solution (10 μl) of AlexaFluor 660 carboxylic acid succinimidyl ester (Alexa-NHS; Molecular Probes, USA; 200 ug) in DMF. The addition was repeated (four times) at intervals (30 min.). The stirring was continued (1 h) and a solution (10 μl) of biotinamidocaproate succinimidyl ester (biotin-NHS; Sigma; 200 μg) in DMF was added. The addition was repeated (four times) at intervals (30 min.). After further stirring (1 h) the solution was dialysed against water (4×1 l) at 4° C.

### Competitive Assay

A sample solution was prepared by dissolving TNT in acetonitrile and diluting to suitable concentration with PBS solution containing BSA (PBS-BSA; 10 mg/ml). The suspension array (as follows 5G-PETN, 5G-5R-TNT and 5G-5R-5Y-RDX) was suspended in the sample solution (0.5 ml) and the mixture diluted (1:2) with a solution of biotinylated antibodies to PETN, TNT and RDX in PBS-BSA to 25 nM each antibody.

The suspension array was slow tilt rotated (30 min.), washed with PBS and re-suspended in PBS-BSA containing an excess of polystreptavidin (DakoCytomation, DK, supplied as 5.9 μM dextran solution, mean 19 polystreptavidin molecules per molecule dextran). After further rotation (15 min.), the array was washed with PBS and re-suspended in PBS-BSA containing an excess of AlexaFluor 660 biotinylated dextran. After further rotation (15 min) the array was washed with PBS (3×1 ml) and re-suspended in PBS (25 μl) for epifluorescence imaging.

The biotinylated antibodies to PETN and RDX bind to the corresponding microspheres—but antibodies to TNT do not bind. Consequently, there is no binding of polystrepavidin to the microsphere encoding TNT and no labelling by binding to biotinylated AlexaFluor 660. The microspheres specific for TNT are not visible through the AlexaFluor window (far right of Table I).

### EXAMPLE 3

### Multiplexed Assay

A competitive assay similar to Example 2 was used for sample solutions that contained PETN and RDX in ratios found in Semtex A and Semtex H. The assay reports the presence of these explosive materials at concentrations of PETN and RDX as low as 1000 ppb and 50 ppb respectively.

A second embodiment of the method of the present invention is shown in FIG. 8—steps i) and iii) in aqueous solution and steps ii) and iv) are in chloroform (HCCl₃):

### EXAMPLE 4

### First Layer (Step i)

To the vortexed suspension of washed, paramagnetic epoxy-functionalised microspheres (6 mg) in water (500 μl) was added a solution (500 μl) of branched chain PEI (MW 750 kDa, 100 mg/ml) of 1 M NaCl. After slow tilt rotation overnight, the (PEI) polymer microspheres were washed sequentially with 0.5 M NaCl solution (4×1 ml), 0.1 M sodium borate solution (pH 9.5; 4×1 ml), 0.1M sodium acetate solution (pH 4.5; 4×1 ml) and 0.5 M sodium chloride solution (6×1 ml). The PEI covered microspheres were re-suspended in water and stored at 4° C.

Microelectrophoresis measurements (FIG. 9) confirm the deposition of PEI layer—the negative ζ-potential of the epoxy-functionalised microspheres becomes positive.

### First Coating (Step ii)

PEI polymer microspheres were magnetically precipitated from a suspension (60 μg) in water (20 μl) and washed with HPLC grade water (pH 6.5; 4×1 ml) and then methanol (4×1 ml). The microspheres were re-suspended in chloroform (1 ml) and to the suspension was added an excess of TOPO-capped green quantum dot. The mixture was slow tilt rotated (1 h). The coated microspheres were magnetically precipitated and washed with chloroform (1 ml), methanol (4×1 ml) and then water (1 ml).

Microelectrophoresis measurements (FIG. 9) confirm the deposition of the quantum dot coating—the ζ-potential of the microspheres again becomes less positive.

### Intervening Layers

The coated microspheres were slow tilt rotated (1 h) with a solution (1 ml, pH 8.0) of 0.5 M NaCl containing PEI (1 mg/ml). The PEI covered microspheres were magnetically precipitated, washed with water (4×1 ml) and then slow tilt rotated (1 h) with a solution (1 ml, pH 6.0) of 0.5 M NaCl containing PSS (1 mg/ml).

The inclusion of the priming layers is confirmed by microelectrophoresis measurements (FIG. 9)—the ζ-potential of the microspheres becomes negative following treatment with PSS and then positive following treatment with PEI.

### Second Layer (Step iii)

After magnetic precipitation, the PSS covered microspheres were washed with water (4×1 ml) and slow tilt rotated (1 h) with a solution (1 ml, pH 8.0) of 0.5 M NaCl containing PEI (1 mg/ml).

### Second Coating (Step iv)

The PEI covered microspheres were washed with HPLC grade water (4×1 ml) and methanol (4×1 ml) and re-suspended in chloroform (1 ml). To the suspension was added an excess of TOPO-capped quantum dot and the mixture was slow tilt rotated (1 h). The coated microspheres were magnetically precipitated and washed with chloroform (1 ml), methanol (4×1 ml) and then water (1 ml).

### Subsequent Layers and Coatings

PEI covered (1G) microspheres were obtained and coated with TOPO-capped red quantum dots according to the steps described above. The PEI (1G-1R) microspheres so obtained were similarly coated with TOPO-capped yellow quantum dots to give PEI covered (1G-1R-1Y) microspheres.

The successive deposition of PEI layer and quantum dot coating is confirmed by microelectrophoresis measurements (FIG. 8)—again an oscillation in positive values of ζ-potential again is seen.

FIG. 10 a) shows the UV/visible spectra obtained when these steps (5G-5R) are applied to a quartz cuvette. Again a linear increase in the absorbance of the first exciton peak when multiple coatings of the same quantum dot are deposited is found.

### Vitreous Overcoat

To a suspension of (1G-1R-1Y) encoded (PEI/PSS/PEI) microspheres (60 μg) in water (1 ml) was added an excess of silica nanoparticle (Ludox® TM-40; SiNP) and the mixture (pH 9.5) slow tilt rotated (1 h). The SiNP covered microspheres were magnetically precipitated and washed with water (4×1 ml). The microspheres were slow rotated with a 0.5 M NaCl solution (1 ml, pH 8.0) containing PEI (MW 10 kDa; 1 mg/ml).

The steps were repeated to give (1G-1R-1Y) encoded microspheres including protective layers SiNP/PEI/SiNP/PEI/SiNP.

The successive deposition of PEI layer and SiNP coating is confirmed by microelectrophoresis measurements (FIG. 2)—the ζ-potential of the microspheres oscillates between positive and negative values.

UV/visible measurements show that the protective layers do not increase the absorbance of the microspheres in the range 200-700 nm or decrease the intensity of the photoemission spectrum.

Referring now to FIG. 11 SEM a) and b) and AFM c) images of surfaces obtained following assembly of three coatings of quantum dots (III) and a SiNP protective layers (IV) on epoxy-functionalised microspheres (b) and on epoxy-functionalised glass microslides (a, c) show that the surfaces are not noticeably rough compared to the surfaces of the starting microspheres and slides (I). Indeed, the surface of SiNP covered microspheres (b-IV) appears smoother than the surface of the epoxy-functionalised microsphere.

As may be seen, the size of the microspheres after the application of the overcoat (b-IV) is similar to the size of the unloaded microspheres (b-I).

The core-shell structure is again confirmed by confocal imaging of individual microspheres (not shown).

Referring now to FIGS. 10 b) and c) the photoemission spectra obtained from a library of 1G (I), 1G-1R (II) and 1G-1R-1Y (III) encoded microspheres again show that the intensity of luminescence from green quantum dots decreases when the microsphere includes quantum dots emitting at longer wavelength (red). The effect may be due to radiative and/or non-radiative energy transfer.

Referring now to FIG. 12, the photoluminescence intensities of microspheres including 1 to 5 layers of the same quantum dot show four distinctly resolvable groups of microsphere.

### PDP-functionalised Albumin

To a stirred a 0.1 M sodium bicarbonate solution (1 ml; pH 8.6) containing albumin (10 mg; albumin (chicken egg white; OVA); bovine serum albumin (BSA), human serum albumin (HSA); Sigma) was added drop wise a solution (100 μl) of SPDP (0.2 mg) in DMF. After further stirring (1 h) the PDP-albumin was purified by gel exclusion chromatography (Sephadex G25).

The molar ratio of PDP to albumin was determined as ˜2:1 by UV absorbance measurements (PDP at 343 nm after reduction with dithiothreitol (DTT); albumin at 280 nm corrected for PDP).

### Albumin Microspheres

(5G-5R-5Y) Encoded microspheres (60 μg) including protective SiNP/PEI/SiNP/PEI/SiNP layers mentioned above were washed with ethanol (4×1 ml) and slow tilt rotated (overnight) with a mixture (1 ml) of (95/3/2) ethanol/water/aminopropyltriethoxysilane (APTS). The microspheres were washed with ethanol (4×1 ml) and re-suspended in 0.1 M sodium bicarbonate solution (0.5 ml). The microspheres were added to a solution (0.5 ml) of 0.1 M sodium bicarbonate solution containing 2-iminothiolane, hydrochloride salt (1 mg) and the mixture slow tilt rotated (30 min.).

After washing with 0.1 M sodium bicarbonate solution (4×1 ml), the microspheres were re-suspended in PBS (1 ml) containing PDP-albumin (0.5 mg). The mixture was slow tilt rotated (overnight) and the microspheres washed with PBS (4×1 ml). The microspheres were then slow tilt rotated (1 h) with blocking solution (PBS containing gelatin (cold water fish skin; 10 mg/ml; 1 ml) and washed with PBS (4×1 ml) and stored in darkness.

Referring now to FIG. 13 b), a competitive assay for BSA employed a suspension array of encoded microspheres produced according to Example 4:

### EXAMPLE 5

### Competitive Assay

A suspension array was prepared by mixing equal amounts of Example 3 encoded microspheres as follows 3G-OVA, 2G-1R-BSA and 5G-5R-5Y-HSA in antibody diluent. A sample solution (10 μg/ml) was prepared by dissolving BSA albumin in antibody diluent containing anti-albumin (anti-OVA, anti-BSA (mouse ascites fluid), anti-HSA; Sigma; IgG 5 μg/ml).

The suspension array was incubated with the sample solution (1:1 v/v) and the mixture slow tilt rotated (15 min.). The microspheres were magnetically precipitated and washed with PBS containing 0.05% Tween-20® (1×1 ml).

The microspheres were then slow tilt rotated in antibody diluent containing Cy-5-labelled antimouse antibodies (AbCam, UK); IgG 10 μg/ml), washed with PBS containing Tween® and imaged with an epifluorescence microscope.

The table shows that no anti-BSA antibody binds to the 2G-1R encoded microsphere because they are bound to BSA in solution. Consequently, when the array is incubated with antibody specific to the antibodies there is no binding to the 2G-1R encoded microspheres. Microspheres specific for BSA are not visible when imaged through the Cy-5 window (far right of Table II).

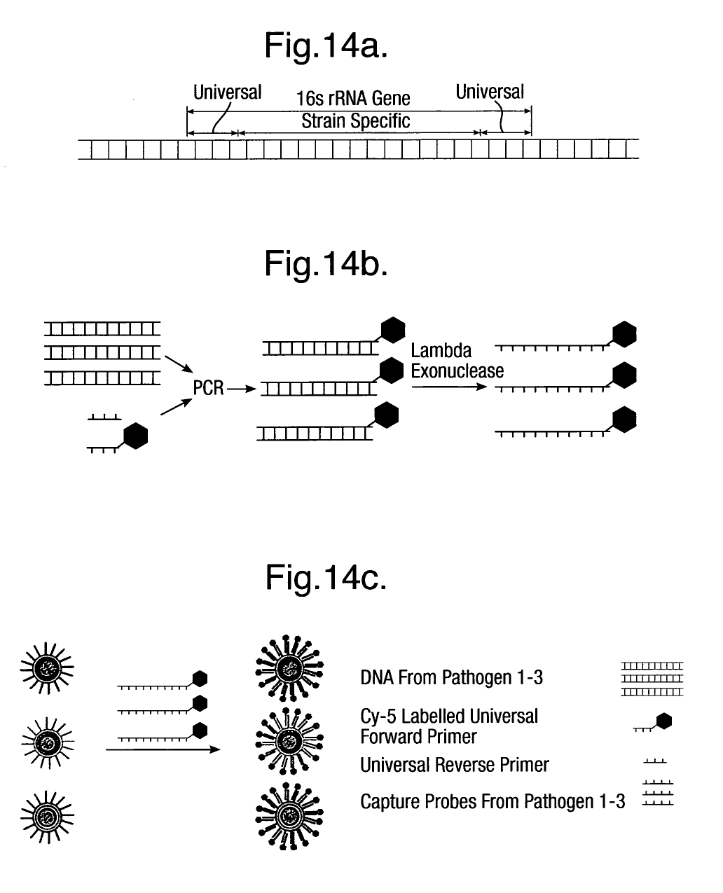

Referring now to FIG. 14, a multiplex assay for detection of target bacteria can rely on amplicification of the 16s ribosomal RNA gene. This gene is present in all bacteria but incorporates specific sequences which vary according to bacterium (A).

Sequences in the gene which are conserved allow for amplification using a single pair of primers, which can bind adjacent the specific sequences, with incorporation of fluorescent dye Cy-5 (B). The single strand oligonucleotide sequences obtained by treatment of the amplified genes with 5→3 exodeoxyribonuclease (λ-exonuclease) are characteristic of the target bacteria.

The presence of the target bacteria can be revealed by fluorescence of the dye following hybridisation with a library of encoded microspheres each coated with streptavidin and conjugated to a doubly biotinylated oligonucleotide probe for one or other of the strands.

FIG. 15 confirms binding of Cy-5 labelled oligonucleotides to commercially available paramagnetic microspheres (A; Dynal) and encoded microspheres according to the present invention (B)—each coated with streptavidin and conjugated to a biotinylated oligonucleotide probe.

As may be seen, both microspheres could detect single stranded DNA—but the encoded microspheres according to the present invention showed stronger images at all concentrations than the commercial microspheres whilst maintaining a low background signal.

Referring now to FIG. 16, an agarose gel chromatogram of the products of a polymerase chain reaction (PCR) on a substrate deoxyribonucleic acid confirms that amplification of the substrate can be obtained with conservation of primers incorporating Cy-5 dye and that the products are converted to single strand oligonucleotides by λ-exonuclease (cf: A4 with B4 and B5; 5 includes enzyme).

### EXAMPLE 6

Encoded microspheres according to the present invention were prepared using TOPO-capped quantum dots as follows:

1M NaCl containing 100 mg ml⁻¹ high molecular weight PEI was mixed 1:1 (v/v) with a vortexed suspension containing 6 mg of washed epoxy microspheres in 500 μl of water, and rotated overnight at room temperature. The microspheres were then washed with 1) 4×1 ml of 0.5 M NaCl; 2) 4×1 ml of 0.1 M sodium borate; 3) 4×1 ml of 0.1 M sodium acetate, pH 4.5; 4) 6×1 ml of 0.5 M NaCl and re-suspended in water.

20 μl (60 μg) of polymer coated paramagnetic microspheres were magnetically precipitated and washed with HPLC grade water (pH 6.5) and 4×1 ml of methanol.

The washed microspheres were rotated in 1 ml chloroform containing an excess of TOPO capped quantum dots for one hour.

Afterwards, the microspheres were magnetically precipitated and washed with 1 ml chloroform, 4×1 ml of methanol and 1 ml of water and then rotated for 1 hour in 1 ml of an aqueous solution containing 1 mg ml⁻¹ PEI and in 0.5 M NaCl (pH 8.0).

The microspheres were then washed with 4×1 ml of HPLC grade water and 4×1 ml of methanol and again rotated in 1 ml of chloroform containing an excess of TOPO capped quantum dots for one hour.

These latter quantum dot and polymer coating steps could be repeated using the same or different quantum dots.

1. A method for encoding a microsphere comprising the steps of i) providing a layer of a polyionic polymer to the microsphere, ii) coating the layer with quantum dots, iii) providing a layer of a transparent polyionic polymer to the coated polymer layer iv) coating the transparent layer with the same and/or different quantum dots and, optionally, repeating steps iii) and iv) whereby to characterise the microsphere by wavelength and/or intensity of its photoemission spectrum on excitation at a predetermined wavelength of incident light.

2. A method according to claim 1, in which the microsphere is paramagnetic.

3. A method according to claim 1, in which the microsphere comprises a latex or silica microsphere.

4. A method according to claim 3, in which the microsphere forms a covalent bond with the polyionic polymer.

5. A method according to claim 1, wherein the polyionic polymer of step i) is transparent.

6. A method according to claim 1, wherein the transparent polyionic polymer comprises a high molecular weight polyamine.

7. A method according to claim 6, in which the polyamine comprises poly(allylamine), poly(ethyleneimine), poly(lysine) or chitin.

8. A method according to claim 1, wherein steps i) and iii) are carried out in a protic solution.

9. A method according to claim 1, wherein steps ii) and iv) are carried out in a protic solution.

10. A method according to claim 9, in which steps i) and iii) are followed by a drying step.

11. A method according to claim 10, in which steps ii) and iv) are followed by a wetting step.

12. A method according to claim 11, in which the drying step and the washing step comprises washing with methanol.

13. A method according to claim 1, wherein step iv) is repeated from 1 to 20 times.

14. A method according to claim 13, in which step iv) is carried out with the same quantum dots as for step ii).

15. A method according to claim 13, in which step iv) is repeated using different quantum dots to any preceding step ii) and/or step iv).

16. A method according to claim 1, further comprising a preliminary step of providing one or more priming layers of a polyionic polymer to the microsphere.

17. A method according to claim 1, further comprising an additional step following step ii) and/or step iii) of providing one or more intervening layers of a polyionic polymer.

18. A method according to claim 1, further comprising the additional step of providing one or more layers of a protective transparent polyionic polymer to the microsphere.

19. A method according to claim 18, comprising coating the protective layer with silica or germanium oxide nanoparticles.

20. A method according to claim 19, comprising the further step of providing a transparent polymer to the silica or germanium nanoparticles coating.

21. A method according to claim 18, comprising the further step of silanizing the protective layer to permit the attachment of a molecule capable of recognising a target molecule.

22. A method according to claim 18, comprising the further step of providing to the protective layer a transparent polymer layer including a moiety capable of recognising a target molecule.

23. An encoded microsphere comprising a latex or silica microsphere coated with a layer of a polyionic polymer coated with a layer of quantum dots coated with a layer of a transparent polyionic polymer coated with a layer of the same or different quantum dots.

24. An encoded microsphere according to claim 23, comprising 1 to 20 different quantum dots.

25. A method of performing multiplexed assays, multiplexed screening or combinatorial chemistry comprising combining the encoded microsphere of claim 23 with a sample containing a target molecule and detecting microsphere-target complexes.

26. The method of claim 25 for the detection of explosive materials.

27. The method of claim 25 wherein the microsphere-target complexes are detected with a lateral flow device.
